(19) United States
(12) Patent Application Publication
(10) Pub. No.: US 2013/0128201 A1
(43) Pub. Date: May 23, 2013

(54) LIQUID CRYSTAL DISPLAY DEVICE AND METHOD FOR PRODUCING SAME

(71) Applicants: Takeshi Noma, Osaka-shi (JP); Masanobu Mizusaki, Osaka-shi (JP); Yohei Nakanishi, Osaka-shi (JP)

(72) Inventors: Takeshi Noma, Osaka-shi (JP); Masanobu Mizusaki, Osaka-shi (JP); Yohei Nakanishi, Osaka-shi (JP)

(73) Assignee: SHARP KABUSHIKI KAISHA, Osaka-shi, Osaka (JP)

(21) Appl. No.: 13/813,216

(22) PCT Filed: Jul. 22, 2011
(86) PCT No.: PCT/JP2011/066686

§ 371 Date: Jan. 30, 2013

(30) Foreign Application Priority Data
Jul. 30, 2010 (JP) 2010-171753

(51) Int. Cl. G02F 1/1337

(52) U.S. Cl. CPC G02F 1/1337
USPC 349/123; 445/24

(57) ABSTRACT

A liquid crystal display device (100) includes: a pair of substrates (10, 20) each having an electrode; a liquid crystal layer (30) interposed between the pair of substrates; at least one photo-alignment layer (12) provided between at least one of the pair of substrates and the liquid crystal layer; and an alignment sustaining layer (14a, 14b) provided on the photo-alignment layer, the alignment sustaining layer containing a polymerization product generated through polymerization of at least one kind of bifunctional monomer. In the liquid crystal layer, at least two regions (R1, R2) are formed in one pixel region, the at least two regions (R1, R2) differing in terms of pretilt angles of liquid crystal molecules as regulated by the photo-alignment layer and the alignment sustaining layer.

### TECHNICAL FIELD

The present invention relates to a liquid crystal display device and a method for producing same, and more specifically to a liquid crystal display device and a method for producing same utilizing the PSA technique.

### BACKGROUND ART

A transmission-type liquid crystal display device includes a liquid crystal display panel and a backlight, and performs displaying by utilizing changes in the alignment direction of liquid crystal molecules based on a voltage which is applied across a liquid crystal layer which is included in the liquid crystal display panel. Conventionally, the alignment direction (pretilt direction) of liquid crystal molecules while no voltage is applied across the liquid crystal layer is regulated by an alignment film. For example, in a TN-mode liquid crystal display panel, pretilt azimuths of liquid crystal molecules are regulated by performing a rubbing treatment for a horizontal alignment film. As used herein, a pretilt azimuth refers to components within the liquid crystal layer plane (within the substrate plane) of a vector which indicates an alignment direction of a liquid crystal molecule in a liquid crystal layer across which no voltage is applied. Note that a pretilt angle, i.e., an angle between the principal face (substrate plane) of an alignment film and a liquid crystal molecule, is primarily determined by the combination of an alignment film and a liquid crystal material. A pretilt direction is expressed in terms of a pretilt azimuth and a pretilt angle.

Liquid crystal display devices of the TN mode, which have often been used conventionally, have relatively narrow viewing angles. In recent years, however, liquid crystal display devices with wide viewing angles have been produced, e.g., the IPS (In-Plane Switching) mode and the VA (Vertical Alignment) mode. Among such modes with wide viewing angles, the VA mode is adopted in a large number of liquid crystal display devices because of an ability to realize a high contrast ratio.

As one kind of VA mode, the MVA (Multi-domain Vertical Alignment) mode is known, under which a plurality of liquid crystal domains are created in one pixel region. An MVA-mode liquid crystal display device includes alignment regulating structures provided on the liquid-crystal-layer side of at least one of a pair of opposing substrates, between which a vertical-alignment type liquid crystal layer is interposed. The alignment regulating structures may be linear slits that are provided in electrodes or ribs (protrusions) provided on electrodes so as to face the liquid crystal layer, for example. The alignment regulating structures provide alignment regulating forces from one side or both sides of the liquid crystal layer, thus creating a plurality of liquid crystal domains (typically four liquid crystal domains) with different alignment directions, whereby the viewing angle characteristics are improved.

In recent years, as a technique for controlling the pretilt direction of liquid crystal molecules, Polymer Sustained Alignment Technology (hereinafter referred to as the “PSA technique”) has been developed (see Patent Documents 1, 2, and 3). The PSA technique is typically a technique where a small amount of photopolymerizable compound (e.g., a photopolymerizable monomer) is added to a liquid crystal material containing liquid crystal molecules, and after this is injected into a liquid crystal cell, the photopolymerizable compound is irradiated with light (e.g., ultraviolet) while applying a predetermined voltage across the liquid crystal layer, so that the generated photopolymerization substance will control the pretilt direction of the liquid crystal molecules. A layer which is formed of the photopolymerization substance will be referred to as an alignment sustaining layer in the present specification.

Adopting the PSA technique allows an alignment state of liquid crystal molecules when generating the photopolymerization substance to be maintained (stored) even after the voltage is removed (i.e., in the absence of an applied voltage). Therefore, the PSA technique has an advantage in that the pretilt azimuths and pretilt angles of liquid crystal molecules can be adjusted by controlling an electric field which is created across the liquid crystal layer, etc. Moreover, since the PSA technique does not require a rubbing treatment, it is particularly suitable for producing a vertical-alignment type liquid crystal layer, whose pretilt direction is difficult to be controlled through a rubbing treatment. The entire disclosure of Patent Documents 1, 2, and 3 is incorporated herein by reference.

Patent Document 4 describes an MVA-mode liquid crystal display device which is produced by using the PSA technique so that two or more regions with different threshold voltages are formed within one pixel region, this being in order to avoid the problematic discrepancy in image chromaticity between when viewed from the frontal direction and when viewed from an oblique direction.

Specifically, a light-shielding or dimming mask is provided locally in predetermined regions within one pixel region, and by performing a process of radiating light while applying a predetermined voltage across the liquid crystal layer, a monomer contained in the liquid crystal layer is allowed to polymerize in the exposed regions (i.e., regions where no mask is provided) either selectively or with a higher priority. Thereafter, the entire pixel region is irradiated with light while varying the intensity of irradiation light or the applied voltage, etc., whereby the remaining monomer in the liquid crystal layer becomes polymerized. This ensures that, in the absence of an applied voltage, different alignments of liquid crystal molecules exist between the masked regions and the exposed regions. Thus, in the liquid crystal layer, two regions with different threshold voltages of V-T characteristics (voltage-transmittance characteristics) can be formed within one pixel region.

In the present specification, a “pixel” refers to the smallest unit that expresses a specific gray scale level in displaying; in the case of multicolor displaying, a “pixel” corresponds to a unit that expresses a gray scale level of each of R, G, and B, for example, and is also referred to as a dot. For example, a combination of an R pixel, a G pixel, and a B pixel composes a single color displaying pixel. A “pixel region” refers to a region of a liquid crystal panel that corresponds to a “pixel” in displaying.

Similarly, Patent Document 5 describes a technique of forming two regions with different threshold voltages in one pixel region of an MVA-mode liquid crystal display device. In Patent Document 5, too, local masking is provided within one pixel region, and a monomer which is added in the liquid crystal layer is polymerized through two light irradiation steps.

Thus, by providing a plurality of regions with different threshold voltages in one pixel region, the difference in V-T characteristics between an oblique direction and the frontal direction can be alleviated. As a result of this, whitening (a phenomenon where a luminance (transmittance) in an oblique direction becomes higher than a luminance in the frontal direction) in gray scale displaying can be suppressed, in particular.

### CITATION LIST

### Patent Literature

[Patent Document 1] Japanese Laid-Open Patent Publication No. 2002-357830

[Patent Document 2] Japanese Laid-Open Patent Publication No. 2003-307720

[Patent Document 3] Japanese Laid-Open Patent Publication No. 2006-78968

[Patent Document 4] Japanese Laid-Open Patent Publication No. 2006-317866

[Patent Document 5] Japanese Laid-Open Patent Publication No. 2006-267689

[Patent Document 6] International Publication No. 2009/157207

### SUMMARY OF INVENTION

### Technical Problem

However, in the liquid crystal display device described in Patent Document 4 above, the alignment of liquid crystal molecules is regulated by irradiating the liquid crystal layer with ultraviolet light while controlling the voltage that is applied across the liquid crystal layer. Therefore, a complex fabrication apparatus is required which includes a device for applying a voltage across the liquid crystal panel and a device for radiating light, thus resulting in a problem of increased production costs. In this liquid crystal display device, the pretilt azimuths of liquid crystal molecules are defined by slits which are provided in a TFT substrate, while their pretilt angles are regulated by a vertical alignment film and a polymerization product which is provided thereon by the PSA technique.

Conducting a polymerization process of the PSA technique while applying a voltage across the liquid crystal layer in such manners also has the following problem. For example, when a liquid crystal layer is formed through dropwise application of a liquid crystal material, a large-sized mother glass substrate is cut up to obtain each liquid crystal panel. When simultaneously producing a plurality of liquid crystal panels in this manner, it is necessary to form special wiring lines on the mother glass substrate in order to simultaneously apply a voltage to the respective liquid crystal panels. Especially when producing a liquid crystal panel of a large size, it is difficult to uniformly apply a voltage across the liquid crystal layer in each pixel, and conducting light irradiation while a non-uniform voltage is being applied will cause the pretilt angle to vary.

Moreover, in the liquid crystal display devices described in Patent Document 4 and Patent Document 5 above which are to be driven under the MVA mode, patterned structures defining protrusions and slits are formed within the pixel region; however, these have a low light transmittance, thus resulting in a problem of lowering the aperture ratio of the pixel. In this case, it is difficult to obtain a liquid crystal display device with a high luminance.

On the other hand, as a method of aligning liquid crystal molecules of a liquid crystal display device without lowering the pixel aperture ratio, a technique of using an alignment film which acquires an alignment regulating force through light irradiation is known. In the present specification, any such alignment film to which an alignment regulating force is imparted through light irradiation will be referred to as a “photo-alignment film”. Patent Document 6 describes a liquid crystal display device having a photo-alignment film, and describes forming the photo-alignment film by radiating light onto an alignment film which is composed of a polymer, the polymer including a polyimide main chain and a side chain having a photoreactive functional group, the photoreactive functional group being a cinnamate group, for example. Patent Document 6 also describes a technique of, in a liquid crystal display device having a photo-alignment film, forming an alignment sustaining layer which contains a polymerization product of a monomer by applying the PSA technique.

However, although this liquid crystal display device provides for improved viewing angle characteristics, it represents no special constitution against the problem of whitening in gray scale displaying which occurs under viewing from an oblique direction.

The present invention has been made in view of the above problems, and an objective thereof is to provide a liquid crystal display device having a high luminance and improved viewing angle characteristics especially in gray scale displaying, as well as a method of producing the same.

### Solution to Problem

A liquid crystal display device according to the present invention is a liquid crystal display device comprising: a pair of substrates each having an electrode; a liquid crystal layer interposed between the pair of substrates; at least one photo-alignment layer provided between at least one of the pair of substrates and the liquid crystal layer; and an alignment sustaining layer provided on the photo-alignment layer, the alignment sustaining layer containing a polymerization product generated through polymerization of at least one kind of bifunctional monomer, wherein, in the liquid crystal layer, at least two regions are formed in one pixel region, the at least two regions differing in terms of pretilt angles of liquid crystal molecules as regulated by the photo-alignment layer and the alignment sustaining layer.

In a preferred embodiment, the liquid crystal layer has negative dielectric anisotropy; and the photo-alignment layer is a photo-alignment type vertical alignment film.

In a preferred embodiment, as the photo-alignment layer for vertically aligning the liquid crystal molecules, an alignment film material containing a photoreactive functional group is used, the contained photoreactive functional group being one selected from the group consisting of a chalcone group, a coumarin group, a cinnamate group, an azobenzene group, and a tolan group.

In a preferred embodiment, at least one kind of monomer composing the alignment sustaining layer is represented by the following structural formula.

P¹-A¹-(Z¹-A²)ₙ-P²

(In the formula, P¹ and P² represent the same or different ones of an acrylate group, a methacrylate group, a vinyl group, a vinyloxy group, and an epoxy group. A¹ and A² each independently represent a 1,4-phenylene group, a naphthalene-2,6-diyl group, an anthracene-2,6-diyl group, or a phenanthrene-2,7-diyl group, where any H in the ring structure may be substituted by a halogen group, a methyl group, an ethyl group, or a propyl group, or are heterocyclic structures. Z¹ represents COO, OCO, O, CO, NHCO, CONH, or S, or directly-bonding A¹ and A² or A² and A². n is 0, 1, or 2.)

In a preferred embodiment, at least one kind of monomer composing the alignment sustaining layer is represented by the following structural formula.

P¹-A¹-P¹

(In the formula, P¹ represents a methacrylate group. A¹ represents any one of the following cyclic aromatic groups. Any hydrogen may be substituted by a halogen group, a methyl group, an ethyl group, or a propyl group.)

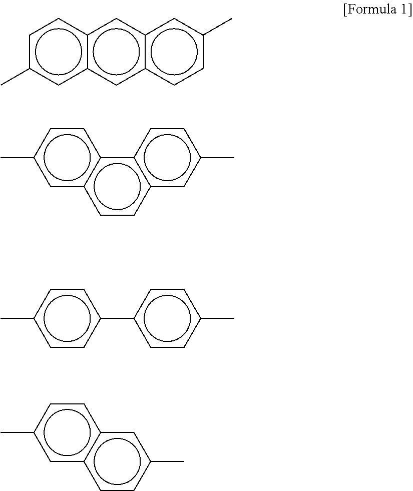

A method of producing a liquid crystal display device according to the present invention comprises: a step of providing a pair of substrates each having an electrode; a step of providing a liquid crystal layer interposed between the pair of substrates, the liquid crystal layer containing a bifunctional monomer; a step of forming at least one photo-alignment layer between at least one of the pair of substrates and the liquid crystal layer; and a step of forming an alignment sustaining layer on the photo-alignment layer, the alignment sustaining layer containing a polymerization product generated from the bifunctional monomer contained in the liquid crystal layer, the step of forming the alignment sustaining layer including: a step of locally providing in a pixel region a light-shielding member for shading light radiated onto the liquid crystal layer; a first irradiation step of selectively radiating light onto a region not shaded by the light-shielding member; and a second irradiation step of removing the light-shielding member and radiating light onto a region shaded in the first irradiation step, wherein a pretilt angle of liquid crystal molecules in the unshaded region of the liquid crystal layer is different from a pretilt angle of liquid crystal molecules in the shaded region.

In a preferred embodiment, the step of forming the photo-alignment layer includes a step of radiating light from a first direction which differs by a predetermined angle from a substrate normal direction; and in the step of forming the alignment sustaining layer, at least one of the first irradiation step and the second irradiation step includes a step of radiating light from a second direction which is different from the first direction.

In a preferred embodiment, the light radiated from the first direction is polarized ultraviolet, and the light radiated from the second direction is unpolarized ultraviolet.

In a preferred embodiment, the light radiated in the first irradiation step has a illuminance which is smaller than a illuminance of the light radiated in the second irradiation step.

In a preferred embodiment, the light radiated in the first irradiation step has an irradiation time which is shorter than an irradiation time of the light radiated in the second irradiation step.

In a preferred embodiment, the first irradiation step is conducted in the absence of an applied voltage across the liquid crystal layer.

In a preferred embodiment, the first irradiation step is conducted under an applied voltage across the liquid crystal layer.

### Advantageous Effects of Invention

With a liquid crystal display device and a method of producing the same according to the present invention, a high luminance can be realized without providing ribs, slits, or other structures within the pixel region, and also the viewing angle characteristics under gray scale displaying can be improved.

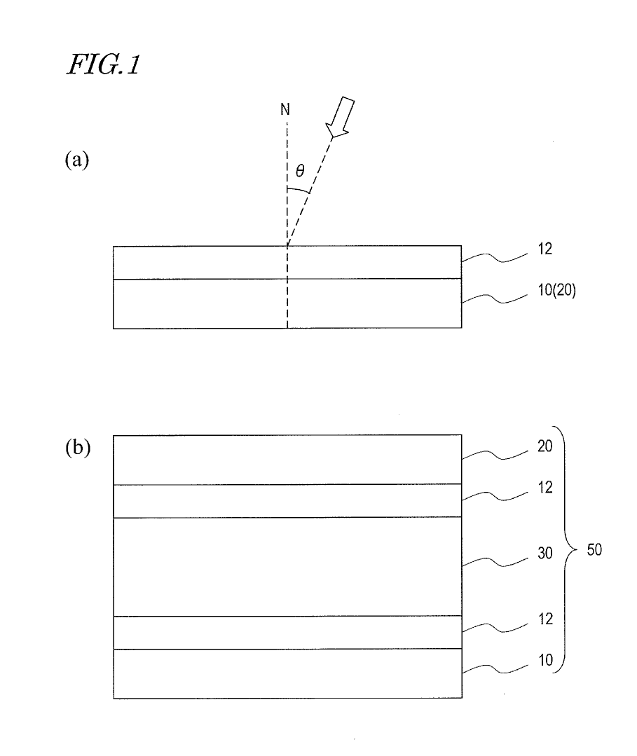

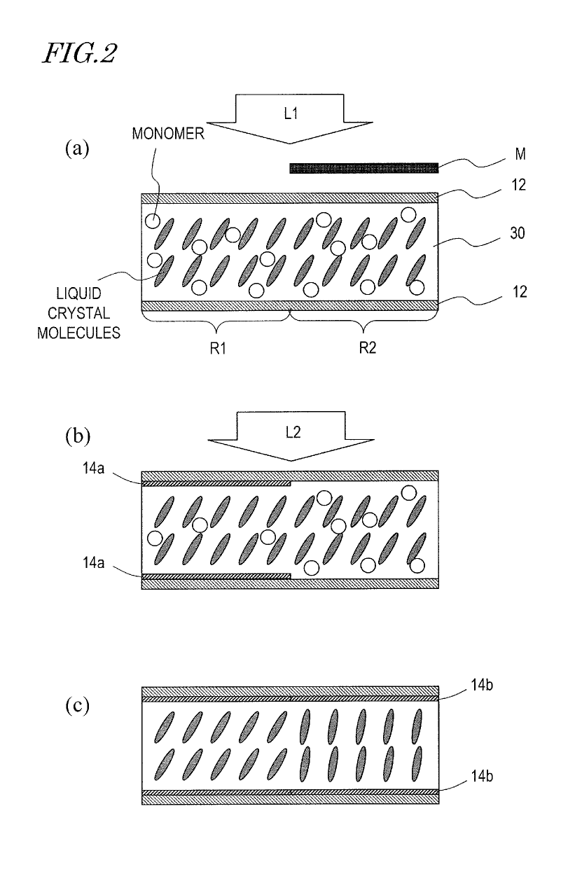

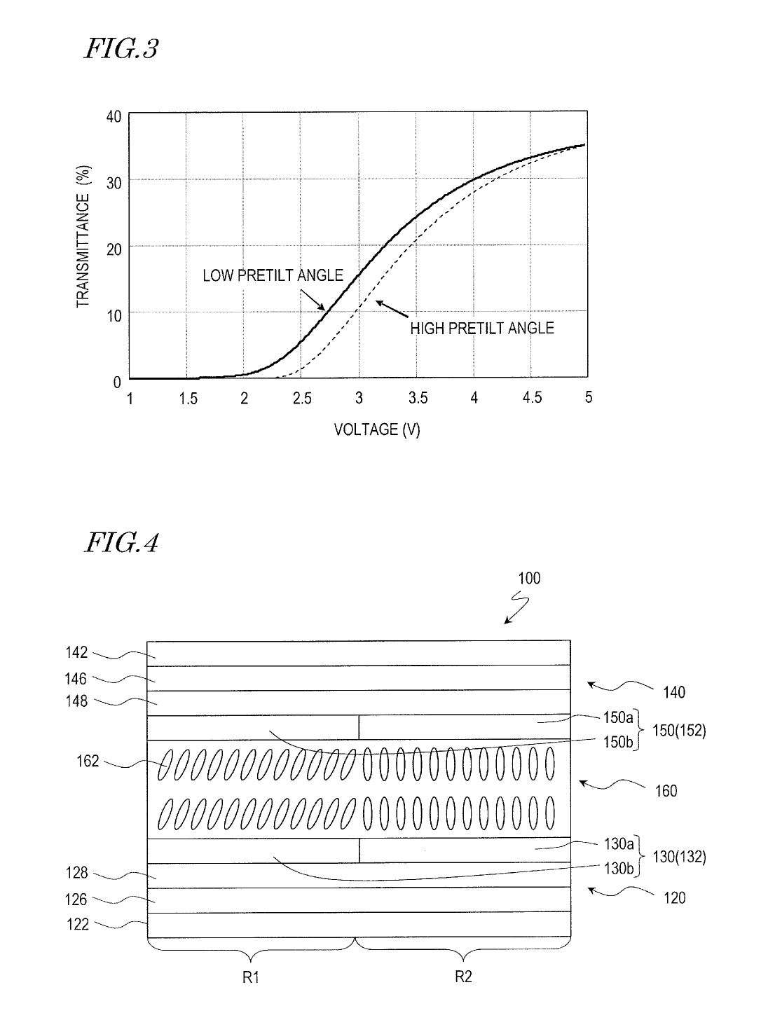

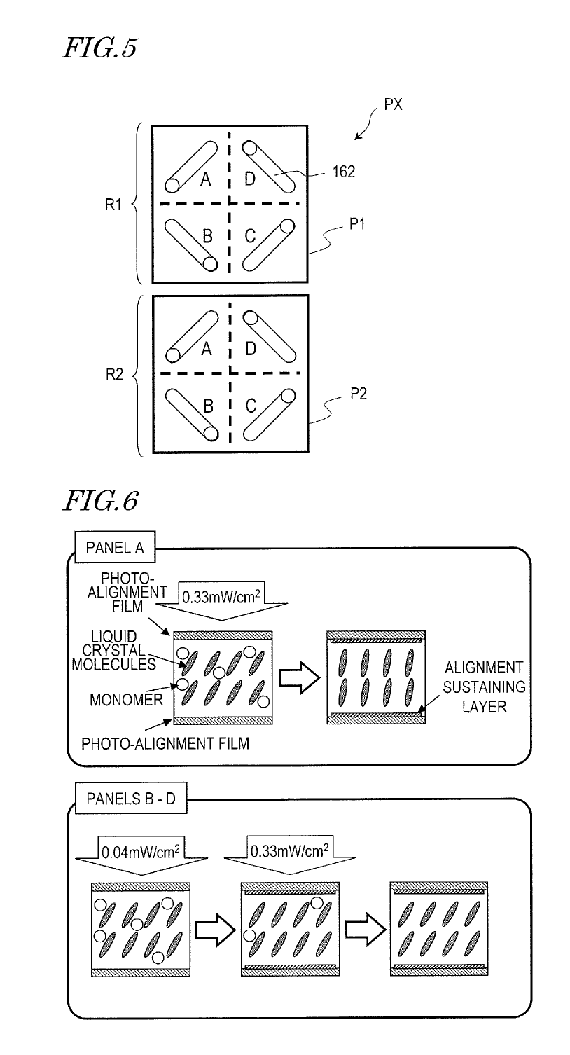

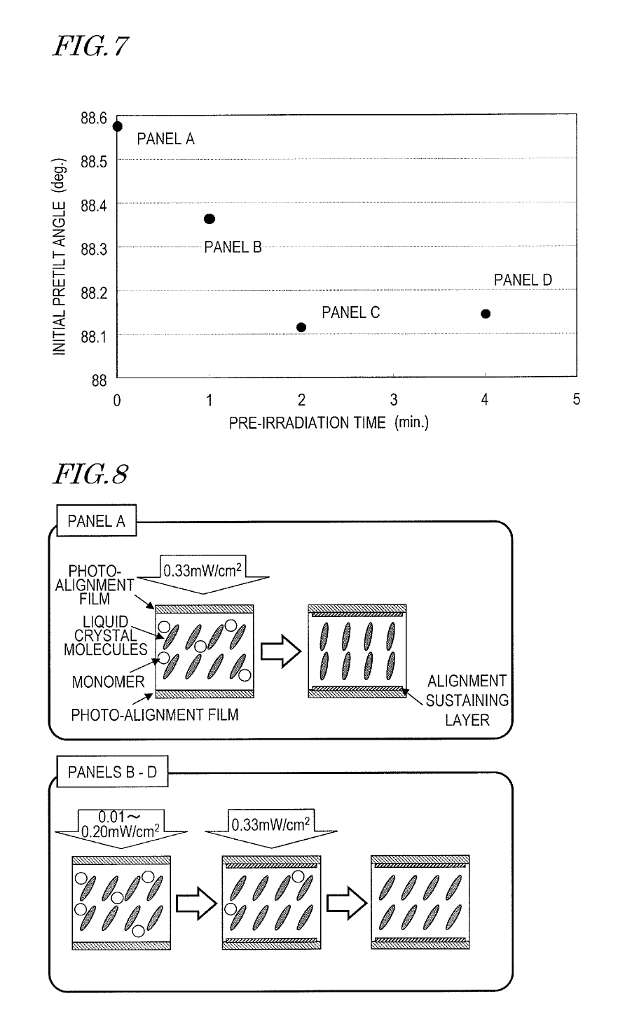

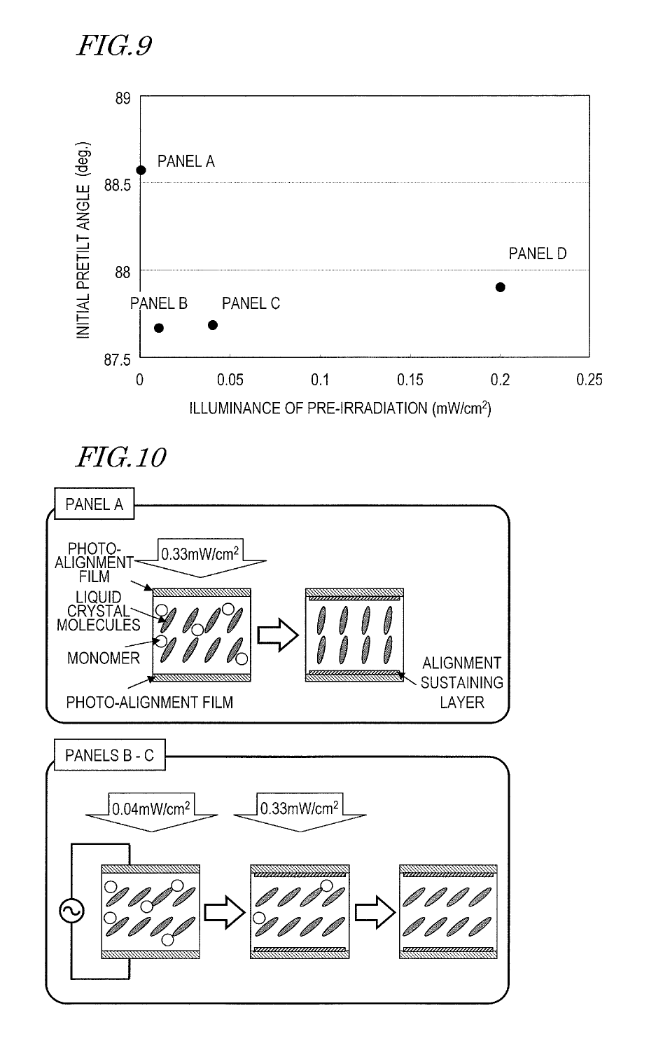

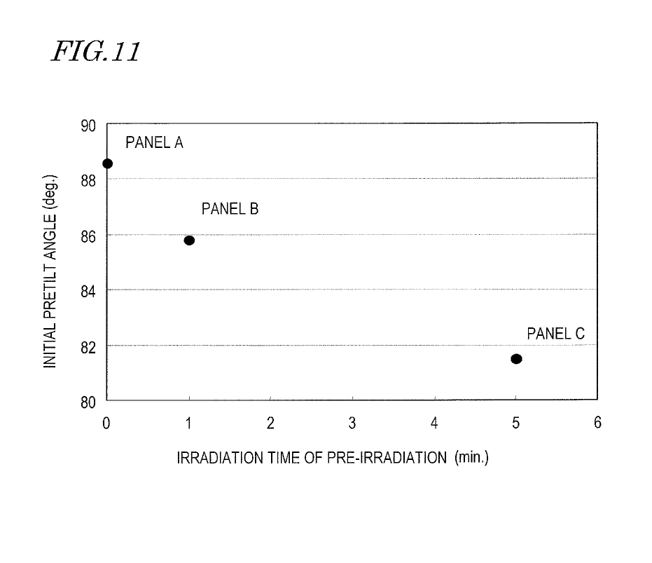

### BRIEF DESCRIPTION OF DRAWINGS

[FIG. 1] Cross-sectional views for explaining a method of producing a liquid crystal display device according to an embodiment of the present invention, where (a) and (b) illustrate respectively different steps.

[FIG. 2] Cross-sectional views for explaining a method of producing a liquid crystal display device according to an embodiment of the present invention, where (a) to (c) illustrate respectively different steps.

[FIG. 3] A graph showing voltage-transmittance characteristics (V-T characteristics) of a liquid crystal display device according to an embodiment of the present invention, in two regions with different pretilt angles.

[FIG. 4] A cross-sectional view showing a liquid crystal display device according to an embodiment of the present invention.

[FIG. 5] An upper plan view showing an alignment state of liquid crystal molecules in a region corresponding to one pixel of a liquid crystal display device according to an embodiment of the present invention.

[FIG. 6] A diagram showing methods of producing panels A to D according to Example 1 of the present invention.

[FIG. 7] A graph showing a relationship between the light irradiation time and the pretilt angle in panels A to D according to Example 1 of the present invention.

[FIG. 8] A diagram showing methods of producing panels A to D according to Example 2 of the present invention.

[FIG. 9] A graph showing a relationship between the light illuminance and the pretilt angle in panels A to D according to Example 2 of the present invention.

[FIG. 10] A diagram showing methods of producing panels A to C according to Example 3 of the present invention.

[FIG. 11] A graph showing a relationship between the light irradiation time and the pretilt angle in panels A to C according to Example 3 of the present invention, under an applied voltage.

### DESCRIPTION OF EMBODIMENTS

First, the present invention will be described in outline before describing embodiments of the present invention in detail.

Conventionally, techniques of forming a plurality of regions with different threshold voltages in one pixel region have been known. However, the aforementioned Patent Document 4 and Patent Document 5 fail to describe any technique of, as in the present invention, forming a photo-alignment film through radiation of light such as ultraviolet light and regulating the alignment of liquid crystal molecules by utilizing the PSA technique. Moreover, in Patent Document 5, when providing regions with different threshold voltages by the PSA technique, the pretilt angle of liquid crystal molecules is not controlled.

On the other hand, although the technique described in Patent Document 6 above utilizes the PSA technique in a liquid crystal display device having a photo-alignment film, there is no mention of forming two regions having different threshold voltages in the liquid crystal layer within one pixel region.

Now, when forming an alignment sustaining layer by polymerizing a monomer within the liquid crystal layer as is also described in Patent Document 6, subjecting a photo-alignment film that has already been formed to a further irradiation of ultraviolet or the like may denature the photo-alignment film. Therefore, it is inconceivable that a method of PSA technique-based alignment regulation which is applicable to a liquid crystal display device lacking a photo-alignment film would be straightforwardly applicable to a liquid crystal display device having a photo-alignment film.

On the other hand, the inventors have conducted vigorous research and experimentation for a method of utilizing the PSA technique to form a plurality of regions with different threshold voltages in one pixel region, while taking influences on the photo-alignment film and the like into consideration. As a result, it has been found that, after using a photo-alignment film to impart a pretilt angle defining an inclination of a predetermined angle from a substrate normal direction to the liquid crystal molecules, when a bifunctional monomer in the liquid crystal layer is to be polymerized through a predetermined light irradiation process, the pretilt angle that was imparted to the liquid crystal molecules by the photo-alignment film undergoes a change, the degree of change in this angle being controllable by appropriately selecting conditions for the aforementioned light irradiation process.

To be more specific, a predetermined pretilt angle (e.g. 87.5°) having been imparted by a photo-alignment film, the liquid crystal molecules undergo different changes in their tilt angles depending on whether a PSA treatment is previously conducted with light of a relatively low illuminance (pre-irradiation process) or a PSA treatment is conducted only at a stronger illuminance (main irradiation process). For example, when weak light of 0.04 mW/cm² is radiated for several minutes from a substrate normal direction in a pre-irradiation process, the pretilt angle of the liquid crystal molecules tends to be maintained; on the other hand, when stronger light of 0.33 mW/cm² is radiated for 2 hours from a substrate normal direction in a main irradiation process, the pretilt angle increases to become closer to 90°. Herein, a smaller change in the pretilt angle occurs in the region which was previously subjected to a PSA treatment through the pre-irradiation process. In the present specification, the phenomenon where a pretilt angle that is defined by a photo-alignment film or the like changes closer to a predetermined angle (which in the above example is 90°) during a PSA treatment may be referred to as “tilt reversion”.

By thus performing an appropriate irradiation process during a PSA treatment, it is possible to provide two regions having different pretilt angles within one pixel region, the two regions being defined as a region in which tilt reversion occurs, and a region in which tilt reversion does not occur (or hardly occurs). Herein, a graph of V-T characteristics in the region with a large pretilt angle (much tilt reversion) exhibits a shift in the direction of increasing the threshold voltage (e.g. a voltage which would realize a transmittance of 1%), thus presenting itself as a curve which is distinct from a graph of V-T characteristics in the region with a small pretilt angle (little tilt reversion) (see FIG. 3). Thus, it is possible to provide two regions having different threshold voltages within one pixel region, and whitening in gray scale displaying when the liquid crystal display device is viewed from an oblique direction can be suppressed.

Moreover, in the case where the pretilt angle of the liquid crystal molecules is controlled as described above, since the alignment film is subjected to a photo-alignment treatment prior to conducting a PSA treatment, the liquid crystal molecules are tilted from the normal direction of a principal face (or substrate plane) of the photo-alignment film, so that there is no need to apply a voltage across the liquid crystal layer in a photopolymerization step. Therefore, a polymerization product (alignment sustaining layer) based on the PSA technique can be formed by using a relatively inexpensive light irradiation apparatus.

Moreover, since the pretilt direction (pretilt azimuth and pretilt angle) of the liquid crystal molecules is defined by the photo-alignment film and the alignment sustaining layer, there is no need to provide slits, ribs, or rivets on the pixel electrodes and counter electrode. Therefore, an enhanced effective aperture ratio can be obtained. Moreover, it is possible to omit a step of providing ribs or rivets on the pixel electrodes and counter electrode, and thus cost reduction can be achieved.

Hereinafter, a liquid crystal display device according to an embodiment of the present invention and a method of producing the same will be described with reference to the drawings, but the present invention is not limited to the following embodiments.

First, a method of producing a liquid crystal display device according to the present embodiment will be described with reference to FIG. 1 and FIG. 2.

As shown in FIG. 1(a), first, a TFT substrate 10 or a counter substrate 20 is irradiated with polarized ultraviolet from an oblique direction which differs by a predetermined angle θ from a substrate normal direction N, thereby forming a photo-alignment type vertical alignment film 12 (hereinafter referred to as a photo-alignment film 12). An irradiation angle θ which is defined by an angle of the direction of light irradiation relative to the substrate normal direction N is preferably 5° to 75°, and more preferably 30° to 55°.

More specifically, the photo-alignment film 12 can be formed by, for example, forming on the TFT substrate 10 or the counter substrate 20 an alignment film containing a polymer having a photoreactive functional group in its side chain and having polyamic acid and/or polyimide in its main chain, pre-baking this at 90° C. for 1 minute, then post-baking it at 200° C. for 60 minutes, and thereafter irradiating it with polarized ultraviolet, and so on.

As the photoreactive functional group contained in the alignment film material, one selected from the group consisting of a chalcone group, a coumarin group, a cinnamate group, an azobenzene group, and a tolan group can be suitably used.

Note that the aforementioned process of forming the photo-alignment film 12 through ultraviolet irradiation can be carried out in a manner similar to the method described in Patent Document 6. The entire disclosure of Patent Document 6 is incorporated herein by reference.

Thereafter, as shown in FIG. 1(b), a liquid crystal panel 50 is produced so that a liquid crystal layer 30 containing a bifunctional monomer is interposed between photo-alignment films (photo-alignment layers) 12. In the present embodiment, a nematic liquid crystal material having negative dielectric anisotropy is used as the liquid crystal material forming the liquid crystal layer 30, and the liquid crystal layer 30 is a vertical-alignment type. Note that conventional techniques can be applied to the method of producing the TFT substrate 10 and the counter substrate 20 and to the method of producing the liquid crystal panel 50 in such a manner that the liquid crystal layer 30 containing a bifunctional monomer is interposed therebetween.

In the liquid crystal panel 50 as such, the photo-alignment films 12 regulate the alignment direction of the liquid crystal molecules in the liquid crystal layer 30, thus conferring a predetermined pretilt azimuth (which may be arbitrary) and a predetermined pretilt angle (e.g. 87.5°) to the liquid crystal molecules. The alignment direction of the liquid crystal molecules is to be determined in accordance with the irradiation angle θ, the irradiation dose (illuminance and irradiation time), and the like when forming the aforementioned photo-alignment films 12.

As at least one kind of bifunctional monomer to be added to the liquid crystal layer 30, what is represented by the following structural formula is suitably used.

P¹-A¹-(Z¹-A²)ₙ-P²

In the formula, P¹ and P² represent the same or different ones of an acrylate group, a methacrylate group, a vinyl group, a vinyloxy group, and an epoxy group. A¹ and A² each independently represent a 1,4-phenylene group, a naphthalene-2,6-diyl group, an anthracene-2,6-diyl group, or a phenanthrene-2,7-diyl group, where any H in the ring structure may be substituted by a halogen group, a methyl group, an ethyl group, or a propyl group. Moreover, A¹ and A² may be heterocyclic structures. Z¹ represents —COO— group, a —OCO— group, a —O— group, a —CO— group, a —NCHO— group, a —CONH— group, a —S— group, or a single bond. n is 0, 1, or 2. The following structure described in International Publication No. 2009/015744 is one example of the heterocyclic structure.

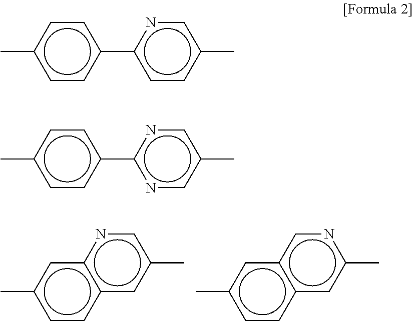

Moreover, this at least one kind of monomer may be what is represented by the following structural formula (i.e., P²=P¹ and n=0 in the above structural formula).

P¹-A¹-P¹

In the formula, P¹ represents a methacrylate group. A¹ represents any one of the following cyclic aromatic groups (an anthracene-2,6-diyl group, a phenanthrene-2,7-diyl group, a 1,4-phenylene group, and a naphthalene-2,6-diyl group). Any hydrogen may be substituted by a halogen group, a methyl group, an ethyl group, or a propyl group.

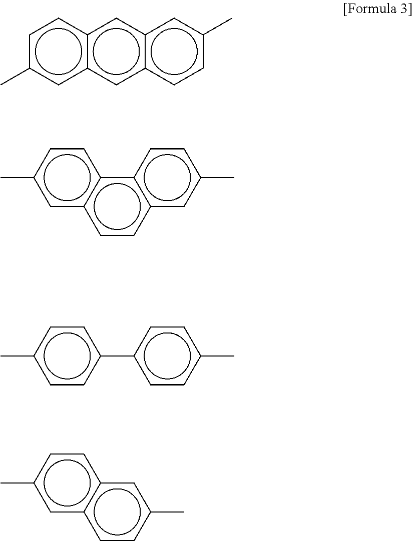

Note that, other than the aforementioned bifunctional monomer, the monomer to be added to the liquid crystal layer may contain a monofunctional monomer or a polyfunctional monomer which is trifunctional or above.

Next, as shown in FIG. 2(a), a light-shielding mask M is locally provided in predetermined regions of the substrate, and unpolarized ultraviolet L1 of a relatively low illuminance (e.g. 0.04 mW/cm²) is radiated for a relatively short time (e.g. 2 minutes) from the substrate normal direction N (pre-irradiation process). As a result of this, the monomer contained in any unmasked region R1 of the liquid crystal layer 30 is polymerized selectively or with a higher priority. Through such a PSA treatment which involves locality within one pixel region, alignment sustaining layers 14a are locally formed on the photo-alignment films 12 (shown in FIG. 2(b)).

Next, as shown in FIG. 2(b), the mask is removed, and a main irradiation process is performed to irradiate the entire pixel region R1, R2, including the irradiated region R1, with unpolarized ultraviolet L2 for a relatively long time (e.g. 120 minutes) from the substrate normal direction N, at a stronger illuminance (e.g. 0.33 mW/cm²) than in the pre-irradiation process. As a result, as shown in FIG. 2(c), the alignment sustaining layers 14a, 14b are formed on the photo-alignment films 12 in the entire pixel region including the pre-irradiated region R1 and the masked region R2. The alignment direction of the liquid crystal molecules in the liquid crystal layer 30 is regulated by the alignment sustaining layers 14a, 14b.

In these two rounds of irradiation process, at least a portion of the monomer in the liquid crystal layer 30 that was selectively polymerized during the pre-irradiation process illustrated in FIG. 2(a) forms the alignment sustaining layers 14a, and the alignment sustaining layers 14a act to anchor the liquid crystal molecules. As a result of this, the pretilt angle of the liquid crystal molecules contained in the pre-irradiated region R1 is maintained at an angle corresponding to the pretilt angle (e.g. 87.5°) defined by the photo-alignment films 12.

On the other hand, when stronger ultraviolet L2 is radiated from the substrate normal direction N during the main irradiation process which is subsequently performed as shown in FIG. 2(b), polymerization of the monomer contained in the liquid crystal layer 30 causes the alignment sustaining layers 14b to be formed in the region R2 so as to increase (closer to 90°) the pretilt angle having been regulated by the photo-alignment film 12 (e.g. to 88.6°), as shown in FIG. 2(c). In the pre-irradiated region R1, there is little remaining monomer and the liquid crystal molecules are already anchored by the alignment sustaining layer 14a, so that the change occurring in their tilt angle is small. Therefore, the angle is maintained closer to the pretilt angle as defined by the photo-alignment films 12 (e.g. 88.1°).

Thus, after a predetermined pretilt angle is conferred to the liquid crystal molecules by using the photo-alignment films 12, a photopolymerization process through main irradiation is performed, whereby the alignment sustaining layers 14b are formed to bring the pretilt angle closer to 90° (i.e., tilt reversion occurs). Moreover, in the photopolymerization process through the pre-irradiation process, the monomer is polymerized to form the alignment sustaining layer 14a and anchor the liquid crystal molecules, whereby tilt reversion can be eliminated or lessened. Thus, by utilizing the characteristic that a varying degree of tilt reversion occurs based on the irradiation dose (illuminance and/or irradiation time) or irradiation angle in a process of polymerizing the monomer in the liquid crystal layer, it is possible to appropriately regulate or control the pretilt angle of the liquid crystal molecules for each predetermined region.

Moreover, when forming the photo-alignment films 12, ultraviolet is radiated from an oblique direction having a predetermined angle θ relative to the substrate normal direction N. By varying the irradiation angle θ, the difference in pretilt angle of the liquid crystal molecules between the region R1 and the region R2 after the PSA treatment step can be controlled. For example, if light irradiation is performed by setting the irradiation angle θ at 20° when forming the photo-alignment films, the pretilt angle of the liquid crystal molecules will be 89.3°; if the irradiation angle θ is 40°, the pretilt angle will be 88.2°; if the irradiation angle θ is set to 60°, the pretilt angle will be 87.5°. Although two rounds of light irradiation are subsequently performed from the normal direction N of the substrates, in the pre-irradiated region R1 which is subjected to the first round of irradiation, the pretilt angle of the liquid crystal molecules tends to be maintained at an angle which is in accordance with the pretilt angle that is defined by the aforementioned photo-alignment films. On the other hand, in the region R2, pretilt reversion occurs so as to result in an angle close to 90°. Thus, the difference in pretilt angle of the liquid crystal molecules between the region R1 and the region R2 varies in accordance with the irradiation angle θ.

As described above, in a liquid crystal display device which is produced by the method of the present embodiment, a plurality of regions having different pretilt angles are formed within one pixel region while maintaining a high transmittance through the use of photo-alignment films, without providing protrusions or slits as in the conventional case. As shown in FIG. 3, the V-T characteristics differ between the region with a relatively small pretilt angle (low pretilt angle) and the region with a relatively large pretilt angle (high pretilt angle), so that the threshold voltage is higher in the high-pretilt angle region than in the low-pretilt angle region. By thus providing two regions of different threshold voltages within one pixel region, whitening in gray scale displaying, which is likely to occur when the liquid crystal display device is viewed from an oblique direction, can be effectively suppressed.

Moreover, according to the present embodiment, the process of creating different pretilt angles within one pixel region is performed in the absence of an applied voltage and during the process of PSA attainment, and therefore can be conducted without affecting the takt time or cost, as compared to conventional PSA techniques. However, as illustrated in Example 3 which will be described later, a predetermined voltage may be applied across the liquid crystal layer when performing light irradiation for polymerizing the monomer during a PSA treatment.

Hereinafter, with reference to FIG. 4, the structure of a liquid crystal display device 100 according to and embodiment of the present invention will be described.

FIG. 4 shows a schematic cross section of the liquid crystal display device 100, indicating a portion corresponding to one pixel.

As shown in FIG. 4, the liquid crystal display device 100 includes an active matrix substrate 120, a counter substrate 140, and a vertical-alignment type liquid crystal layer 160. The active matrix substrate 120 includes a transparent substrate 122, a pixel electrode 126, and an alignment film 128. The counter substrate 140 includes a transparent substrate 142, a counter electrode 146, and an alignment film 148. The liquid crystal layer 160 is interposed between the active matrix substrate 120 and the counter substrate 140.

In the liquid crystal display device 100, pixels are provided in a matrix of plural rows and plural columns, and at least one switching element (e.g., a thin film transistor (TFT) (not shown herein) is provided on the active matrix substrate 120 for each pixel.

Although not shown, a polarizer is provided on the outside of each of the active matrix substrate (or TFT substrate) 120 and the counter substrate 140. The two polarizers are disposed so as to oppose each other with the liquid crystal layer 160 interposed therebetween. The transmission axes (polarization axes) of the two polarizers are positioned so as to be orthogonal to each other, such that one of them extends along the horizontal direction (row direction), whereas the other extends along the vertical direction (column direction).

The liquid crystal layer 160 contains a nematic liquid crystal material having negative dielectric anisotropy (liquid crystal molecules 162). The surfaces of the photo-alignment films 128 and 148 facing the liquid crystal layer are each treated so that the liquid crystal molecules 162 will have a pretilt angle of less than 90°. The pretilt angle of the liquid crystal molecules 162 is an angle between principal faces (or substrate planes) of the photo-alignment films 128 and 148 and the major axis of each liquid crystal molecule which is regulated in a pretilt direction. By irradiating the alignment film 128 or 148 with light from a direction which is oblique with respect to the normal direction of its principal face (or substrate normal direction), an alignment regulating force is applied to the alignment film 128 or 148, whereby the liquid crystal molecules 162 will be aligned so as to be tilted from the normal direction in the absence of an applied voltage.

Such a treatment is also referred to as a photo-alignment treatment. Since a photo-alignment treatment is performed without involving any contact, static electricity and dust will not occur due to friction as will in a rubbing treatment, and thus the production yield can be improved.

Moreover, the photo-alignment films 128 and 148 may each have a plurality of alignment regions for each pixel. For example, by masking a portion of the alignment film 128, and after irradiating a predetermined region of the alignment film 128 with light from a certain direction, another region which was not irradiated with light is now irradiated with light from a different direction. The alignment film 148 is also formed in a similar manner. In this manner, regions for conferring different pretilt azimuths can be formed in each of the alignment films 128 and 148, thus realizing a construction such that four liquid crystal domains are defined within one pixel region, for example. A liquid crystal display device having four liquid crystal domains within one pixel region is described in International Publication No. 2006/132369, for example. A liquid crystal display device of such a pixel construction will be described later.

Although the liquid crystal layer 160 is a vertical-alignment type, the liquid crystal molecules 162 near the interfaces with the active matrix substrate 120 and the counter substrate 140 are slightly tilted from the normal directions of the principal faces of the photo-alignment films 128 and 148. Their pretilt angle is in the range from 85° to 89°, for example.

In the liquid crystal display device 100 of the present embodiment, an alignment sustaining layer 130 (130a, 130b) is provided between the alignment film 128 and the liquid crystal layer 160. The alignment sustaining layer 130 contains a polymerization product 132 resulting from polymerization of a photopolymerizable compound. Moreover, an alignment sustaining layer 150 (150a, 150b) is provided between the alignment film 148 and the liquid crystal layer 160. The alignment sustaining layer 150 contains a polymerization product 152 resulting from polymerization of a photopolymerizable compound. The alignment direction of the liquid crystal molecules 162 is at least defined by the alignment sustaining layers 130 and 150.

Although FIG. 4 illustrates the alignment sustaining layers 130 and 150 in the form of films covering the entire surface of the alignment films 128 and 148, they do not need to be provided so as to cover the entire surface, but may be provided in island shapes.

The polymerization products 132 and 152 in the alignment sustaining layers 130 and 150 are formed by introducing a liquid crystal material in which a photopolymerizable compound (at least containing a bifunctional monomer) is mixed between the alignment film 128 on the active matrix substrate 120 and the alignment film 148 on the counter substrate 140, and thereafter irradiating the photopolymerizable compound with light, as described earlier.

In the liquid crystal display device 100 of the present embodiment, the alignment sustaining layers 130 and 150 are produced by an irradiation process in two rounds with different illuminances and/or irradiation times, as described above. The alignment sustaining layer 130 has different alignment regulating forces between a portion 130a and another portion 130b. The same is also true of the alignment sustaining layer 150. As a result, two regions R1 and R2 in which the liquid crystal molecules have different pretilt angles are formed in the liquid crystal layer 160. The low-pretilt angle region R1 and the high-pretilt angle region R2 correspond to the pre-irradiated region R1 and the non-pre-irradiated region R2, which are shown in FIG. 2 described above.

By using a liquid crystal panel of the above construction, since two regions with different threshold voltages exist in one pixel region, it is possible to improve the viewing angle even when a constant voltage is applied to the pixels, and whitening in gray scale displaying, which is likely to occur when the liquid crystal display device is viewed from an oblique direction, can be effectively suppressed.

Hereinafter, with reference to FIG. 5, an embodiment in which a plurality of alignment regions are created for each pixel by the photo-alignment films 128 and 148 (see FIG. 4) will be described. In this embodiment, the liquid crystal display device is driven in the 4D-RTN (4 Domain-Reverse Twisted Nematic) mode. A liquid crystal display device under the 4D-RTN mode is described in Patent Document 6, for example.

FIG. 5 shows a portion corresponding to one pixel of the liquid crystal display device. As shown in the figure, a pixel PX is divided into a subpixel P1 and a subpixel P2. In each subpixel P1 or P2, liquid crystal molecules 162 have different alignment directions respectively in four liquid crystal domains A, B, C, and D. In FIG. 5, which schematically shows alignment directions of the liquid crystal molecules as viewed from the viewer side, the liquid crystal molecules are tilted so that the end portions (which are essentially circular portions) of the cylindrical liquid crystal molecules point toward the viewer.

In order to provide in the photo-alignment films 128 and 148 regions defining respective liquid-crystal molecule pretilt azimuths corresponding to domains A, B, C, and D, in the course of forming the photo-alignment films 128 and 148, a process of irradiating them with polarized ultraviolet at predetermined angles from the substrate normal direction may be performed, typically in two directions which are 90 degrees apart, as is described in Patent Document 6, for example. In this manner, the subpixels P1 and P2 are constructed so as to comply with the driving under the 4D-RTN mode.

Moreover, in the present embodiment, two regions R1 and R2 in which the liquid crystal molecules 162 have mutually different pretilt angles are formed respectively in the subpixel P1 and the subpixel P2 composing one pixel PX. More specifically, the low-pretilt angle region R1 shown in FIG. 4 is formed in the subpixel P1, and the high-pretilt angle region R2 shown in FIG. 4 is formed in the subpixel 2.

The regions R1 and R2 can be formed through a light irradiation process in two rounds with different irradiation doses, as described above.

Thus, in a 4D-RTN mode liquid crystal display device, too, it is possible to provide two regions having different threshold voltages within one pixel region, whereby the viewing angle of the liquid crystal display device can be improved and whitening in gray scale displaying can be suppressed.

### Example 1

Hereinafter, Example 1 of the present invention will be described with reference to FIG. 6 and FIG. 7.

A photo-alignment film being composed of polyamic acid or polyimide and having a photoreactive functional group in its side chain was produced, and this was pre-baked at 90° C. for 1 minute, and then post-baked at 200° C. for 60 minutes. Next, it was subjected to a photo-alignment treatment through irradiation of polarized UV (ultraviolet) from an oblique direction. At this time, the angle of irradiation and irradiation dose of polarized UV were adjusted so as to attain a pretilt angle of 87.5°±0.2°.

Next, a sealant was applied to one substrate, and after beads were scattered over the counter substrate, these were attached together, and liquid crystal exhibiting negative dielectric anisotropy was injected. In the liquid crystal, 0.3wt % of biphenyldimethacrylate, which is a bifunctional monomer, was introduced.

After liquid crystal injection, heating-quenching was conducted at 130° C., and then polymerization was conducted by radiating light of a low illuminance (0.04 mW/cm²) as a pre-irradiation, and light of a high illuminance (0.33 mW/cm²) as a main irradiation, from the normal direction. When radiating the low-illuminance light, panel A to panel D were produced by varying the irradiation time while employing a constant illuminance (see FIG. 6, where panel A has an irradiation time of 0). Substrates having spread electrodes as the electrodes were used. The irradiation conditions and initial VHRs (voltage holding ratios), and residual DCs of the produced panels are listed in Table 1. Herein, a voltage holding ratio when the panel had a temperature of 70° C. and a pulse voltage of 1 V and 30 Hz was applied was measured as the VHR, and the residual DC was measured after application of a DC voltage of 2 V for 10 hours.

TABLE 1

| | | | panel A | panel B | panel C | panel D |
|---|---|---|---|---|---|---|
| irradia- | pre- | illumi- | | 0.04 | 0.04 | 0.04 |
| tion | irradia- | nance | | mW/cm² | mW/cm² | mW/cm² |
| condi- | tion | irradia- | | 1 min. | 2 min. | 4 min. |
| tions | | tion | | | | |
| | | time | | | | |
| | main | illumi- | 0.33 | 0.33 | 0.33 | 0.33 |
| | irradia- | nance | mW/cm² | mW/cm² | mW/cm² | mW/cm² |
| | tion | irradia- | 2 h | 2 h | 2 h | 2 h |
| | | tion | | | | |
| | | time | | | | |

| | | | | |
|---|---|---|---|---|
| initial VHR | 98.6% | 98.8% | 98.9% | 99.0% |
| residual DC | <50 mV | <50 mV | <50 mV | <50 mV |

As can be seen from Table 1, the initial VHR exhibited longer values for longer pre-irradiation times. Moreover, the residual DC was 50 mV or less, indicative of absence of reliability problems.

As can be seen from FIG. 7, when main irradiation is conducted without any pre-irradiation (pre-irradiation time: 0 minutes), the pretilt angle is 88.6°. By increasing the pre-irradiation time, a pretilt angle which is closer to the value immediately after irradiation of polarized UV is obtained. When 2 minutes or more of irradiation is conducted as pre-irradiation, the pretilt angle is not affected by subsequent irradiation at a high illuminance.

As for the pretilt angle measurement, retardation of each liquid crystal panel was measured according to the Senarmont method for every 6° from −30° to 30°, and a fitting by the crystal rotation method was conducted, thereby calculating a pretilt angle. OMS-AF2 (CHUO PRECISION INDUSTRIAL CO., LTD.) was used as a measurement apparatus. As the light source, a linear polarization He—Ne laser device (wavelength: 632.8 nm, output power: 2 mW) was used, and the measurements were taken under a spot diameter of 1 mm for measurement and a measurement temperature of 25° C.

From the above results, it was found that tilt reversion can be affected and the pretilt angle can be controlled by adjusting the irradiation time in the pre-irradiation process.

### Example 2

Hereinafter, Example 2 of the present invention will be described with reference to FIG. 8 and FIG. 9.

A photo-alignment film being composed of polyamic acid or polyimide and having a photoreactive functional group in its side chain was produced, and this was pre-baked at 90° C. for 1 minute, and then post-baked at 200° C. for 60 minutes. Next, it was subjected to a photo-alignment treatment through irradiation of polarized UV from an oblique direction. At this time, the angle of irradiation and irradiation dose of polarized UV were adjusted so as to attain a pretilt angle of 87.5±0.2°.

Next, a sealant was applied to one substrate, and after beads were scattered over the counter substrate, these were attached together, and liquid crystal exhibiting negative dielectric anisotropy was injected. In the liquid crystal, 0.3wt % of biphenyldimethacrylate, which is a bifunctional monomer, was introduced. After liquid crystal injection, heating-quenching was conducted at 130° C., and then polymerization was conducted by radiating light of a low illuminance (0.01 to 0.20 mW/cm²) as a pre-irradiation, and light of a high illuminance (0.33 mW/cm²) as a main irradiation, from the normal direction. When radiating the low-illuminance light, panels A to D were produced by varying the illuminances while employing a constant irradiation time of 10 minutes (see FIG. 8, where panel A has an illuminance of 0). Substrates having spread electrodes as the electrodes were used. The irradiation conditions and initial VHRs, and residual DCs of the produced panels are listed in Table 2. Herein, a voltage holding ratio when the panel had a temperature of 70° C. and a pulse voltage of 1 V and 30 Hz was applied was measured as the VHR, and the residual DC was measured after application of a DC voltage of 2 V for 10 hours.

TABLE 2

| | | | panel A | panel B | panel C | panel D |
|---|---|---|---|---|---|---|
| irradia- | pre- | illumi- | | 0.01 | 0.04 | 0.20 |
| tion | irradia- | nance | | mW/cm² | mW/cm² | mW/cm² |
| condi- | tion | irradia- | | 10 min. | 10 min. | 10 min. |
| tions | | tion | | | | |
| | | time | | | | |
| | main | illumi- | 0.33 | 0.33 | 0.33 | 0.33 |
| | irradia- | nance | mW/cm² | mW/cm² | mW/cm² | mW/cm² |
| | tion | irradia- | 2 h | 2 h | 2 h | 2 h |
| | | tion | | | | |
| | | time | | | | |

| | | | | |
|---|---|---|---|---|
| initial VHR | 98.6% | 99.3% | 99.1% | 99.0% |
| residual DC | <50 mV | <50 mV | <50 mV | <50 mV |

As can be seen from Table 2, the initial VHR exhibited greater values for weaker pre-irradiation illuminances. Moreover, the residual DC was 50 mV or less, indicative of absence of reliability problems.

As can be seen from FIG. 9, when the pre-irradiation illuminance was 0.01 mW/cm², the pretilt angle was 87.6°, and when the pre-irradiation illuminance was 0.20 mW/cm², the pretilt angle was 87.9°. When 10 minutes of irradiation is conducted at 0.01 mW/cm² or more as pre-irradiation, the pretilt angle is not affected by subsequent irradiation at a high illuminance.

From the above results, it was found that tilt reversion can be affected, and the pretilt angle can be controlled by adjusting the illuminance in the pre-irradiation process.

### Example 3

Hereinafter, Example 3 of the present invention will be described with reference to FIG. 10 and FIG. 11.

A photo-alignment film being composed of polyamic acid or polyimide and having a photoreactive functional group in its side chain was produced, and this was pre-baked at 90° C. for 1 minute, and then post-baked at 200° C. for 60 minutes. Next, it was subjected to a photo-alignment treatment through irradiation of polarized UV from an oblique direction. At this time, the angle of irradiation and irradiation dose of polarized UV were adjusted so as to attain a pretilt angle of 87.5±0.2°.

Next, a sealant was applied to one substrate, and after beads were scattered over the counter substrate, these were attached together, and liquid crystal exhibiting negative dielectric anisotropy was injected. In the liquid crystal, 0.3 wt % of biphenyldimethacrylate, which is a bifunctional monomer, was introduced. After liquid crystal injection, heating-quenching was conducted at 130° C., and then polymerization was conducted by, as a pre-irradiation, radiating light of a low illuminance (0.04 mW/cm²) from the normal direction while applying a voltage (10 V) to the panel, and as a main irradiation, radiating light of a high illuminance (0.33 mW/cm²) from the normal direction (in the absence of an applied voltage) (see FIG. 10). Substrates having spread electrodes as the electrodes were used. The irradiation conditions and initial VHRs, and residual DCs of produced panels A to C are listed in Table 4. Herein, a voltage holding ratio when the panel had a temperature of 70° C. and a pulse voltage of 1 V and 30 Hz was applied was measured as the VHR, and the residual DC was measured after application of a DC voltage of 2 V for 10 hours.

TABLE 3

| | | | panel A | | panel B | | panel C | |
|---|---|---|---|---|---|---|---|---|
| irradiation | pre- | illuminance | | | 0.04 | mW/cm² | 0.04 | mW/cm² |
| conditions | irradiation | irradiation | | | 1 | min. | 5 | min. |
| | (voltage | time | | | | | | |
| | application) | | | | | | | |
| | main | illuminance | 0.33 | mW/cm² | 0.33 | mW/cm² | 0.33 | mW/cm² |
| | irradiation | irradiation | 2 | h | 2 | h | 2 | h |
| | | time | | | | | | |

| | | | |
|---|---|---|---|
| initial VHR | 98.6% | 98.7% | 98.8% |

As can be seen from Table 3, the initial VHR exhibited longer values for longer pre-irradiation times. Moreover, the residual DC was 50 mV or less, indicative of absence of reliability problems.

As can be seen from FIG. 11, when no pre-irradiation was conducted, the pretilt angle was 88.6°; and when 5 minutes of irradiation was conducted as a pre-irradiation while applying a voltage of 10 V, the pretilt angle was 81.5°.

The above results indicate that, even when a voltage is being applied to the liquid crystal layer in a pre-irradiation process, tilt reversion can be affected and the pretilt angle can be controlled by adjusting the irradiation time.

### INDUSTRIAL APPLICABILITY

The present invention is broadly applicable to various liquid crystal display devices, such as liquid crystal television sets.

### REFERENCE SIGNS LIST

10 TFT substrate
12 photo-alignment type vertical alignment film (photo-alignment film)
14a, 14b alignment sustaining layer
20 counter substrate
30 liquid crystal layer
50 liquid crystal panel
N substrate normal direction
R1 pre-irradiated region (low-pretilt angle region)
R2 masked region (high-pretilt angle region)

1. A liquid crystal display device comprising:
a pair of substrates each having an electrode;
a liquid crystal layer interposed between the pair of substrates;
at least one photo-alignment layer provided between at least one of the pair of substrates and the liquid crystal layer; and
an alignment sustaining layer provided on the photo-alignment layer, the alignment sustaining layer containing a polymerization product generated through polymerization of at least one kind of bifunctional monomer, wherein,
in the liquid crystal layer, at least two regions are formed in one pixel region, the at least two regions differing in terms of pretilt angles of liquid crystal molecules as regulated by the photo-alignment layer and the alignment sustaining layer.

2. The liquid crystal display device of claim 1, wherein,
the liquid crystal layer has negative dielectric anisotropy; and
the photo-alignment layer is a photo-alignment type vertical alignment film.

3. The liquid crystal display device of claim 2, wherein, as the photo-alignment layer for vertically aligning the liquid crystal molecules, an alignment film material containing a photoreactive functional group is used, the contained photoreactive functional group being one selected from the group consisting of a chalcone group, a coumarin group, a cinnamate group, an azobenzene group, and a tolan group.

4. The liquid crystal display device of claim 1, wherein at least one kind of monomer composing the alignment sustaining layer is represented by the following structural formula.
P¹-A¹-(Z¹-A²)ₙ-P²
(In the formula, P¹ and P² represent the same or different ones of an acrylate group, a methacrylate group, a vinyl group, a vinyloxy group, and an epoxy group. A¹ and A² each independently represent a 1,4-phenylene group, a naphthalene-2,6-diyl group, an anthracene-2,6-diyl group, or a phenanthrene-2,7-diyl group, where any H in the ring structure may be substituted by a halogen group, a methyl group, an ethyl group, or a propyl group, or are heterocyclic structures. Moreover, A¹ and A² may be heterocyclic structures. Z¹ represents a —COO— group, a —OCO— group, a —O— group, a —CO— group,

5. The liquid crystal display device of claim 1, wherein at least one kind of monomer composing the alignment sustaining layer is represented by the following structural formula.
P¹-A¹-P¹
(In the formula, P¹ represents a methacrylate group. A¹ represents any one of the following cyclic aromatic groups. Any hydrogen may be substituted by a halogen group, a methyl group, an ethyl group, or a propyl group.)

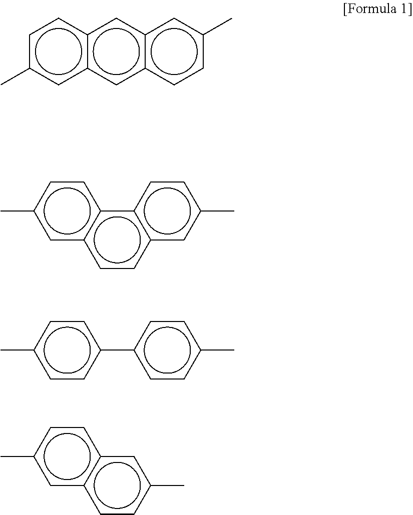

6. A method of producing a liquid crystal display device, comprising:
a step of providing a pair of substrates each having an electrode;
a step of providing a liquid crystal layer interposed between the pair of substrates, the liquid crystal layer containing a bifunctional monomer;
a step of forming at least one photo-alignment layer between at least one of the pair of substrates and the liquid crystal layer; and
a step of forming an alignment sustaining layer on the photo-alignment layer, the alignment sustaining layer containing a polymerization product generated from the bifunctional monomer contained in the liquid crystal layer,
the step of forming the alignment sustaining layer including:
a step of locally providing in a pixel region a light-shielding member for shading light radiated onto the liquid crystal layer;
a first irradiation step of selectively radiating light onto a region not shaded by the light-shielding member; and
a second irradiation step of removing the light-shielding member and radiating light onto a region shaded in the first irradiation step, wherein
a pretilt angle of liquid crystal molecules in the unshaded region of the liquid crystal layer is different from a pretilt angle of liquid crystal molecules in the shaded region.

7. The method of producing a liquid crystal display device of claim 6, wherein,
the step of forming the photo-alignment layer includes a step of radiating light from a first direction which differs by a predetermined angle from a substrate normal direction; and
in the step of forming the alignment sustaining layer, at least one of the first irradiation step and the second irradiation step includes a step of radiating light from a second direction which is different from the first direction.

8. The method of producing a liquid crystal display device of claim 7, wherein the light radiated from the first direction is polarized ultraviolet, and the light radiated from the second direction is unpolarized ultraviolet.

9. The method of producing a liquid crystal display device of claim 6, wherein the light radiated in the first irradiation step has a illuminance which is smaller than a illuminance of the light radiated in the second irradiation step.

10. The method of producing a liquid crystal display device of claim 6, wherein the light radiated in the first irradiation step has an irradiation time which is shorter than an irradiation time of the light radiated in the second irradiation step.

11. The method of producing a liquid crystal display device of claim 6, wherein the first irradiation step is conducted in the absence of an applied voltage across the liquid crystal layer.

12. The method of producing a liquid crystal display device of claim 6, wherein the first irradiation step is conducted under an applied voltage across the liquid crystal layer.
